(19) United States
(12) Patent Application Publication
(10) Pub. No.: US 2011/0066932 A1
(43) Pub. Date: Mar. 17, 2011

(54) SYSTEM AND METHOD FOR PROVIDING A REPRESENTATION OF HIERARCHICAL STRUCTURES OF DOCUMENTS

(75) Inventor: Eric Worrall, March (GB)

(73) Assignee: Global Graphics Software Limited, Cambourne (GB)

(21) Appl. No.: 12/879,301

(22) Filed: Sep. 10, 2010

Related U.S. Application Data
(60) Provisional application No. 61/241,722, filed on Sep. 11, 2009.

(51) Int. Cl. G06F 3/048; G06F 17/00

(52) U.S. Cl. 715/209; 715/776

(57) ABSTRACT

A method of presenting documents includes providing a single file comprising a plurality of documents, an identifier for each of the plurality of documents, and an indicator for each of the plurality of documents to indicate in which one of a plurality of predefined sections that document belongs and to indicate a position of that document in that section. Each document has been created individually and added to the single file. The method further includes displaying a graphical interface that appears as a notebook binder with a plurality of tabs, each tab corresponding to a one of the plurality of sections; and displaying a portion of at least one of the plurality of documents on a graphical page of the notebook binder of the graphical interface.

### CROSS-REFERENCE TO RELATED APPLICATIONS

This patent application claims the benefit of U.S. Provisional Patent Application Ser. No. 61/241,722 filed on Sep. 11, 2009, which is incorporated herein by reference.

### BACKGROUND

Many people who use computers in their day-to-day business are not computer experts. It would often be counter-productive to require them to be; they are needed for their other skills. As a result one of the challenges in designing software applications that will be used on computer workstations is to ensure that the users of such software can perform the tasks of their jobs rapidly and efficiently. If the user interface for an application is complex or confusing then an organization may provide significant training for their employees to use the application and may supply help desk personnel to deal with queries and problems; both of which may reduce productivity and increase the total cost of using the software.

Over the past few decades it has become commonplace to represent page-based documents on a computer display in a roughly consistent way, often as a more-or-less white rectangle with the same aspect ratio as a printed page, shown against a gray, black or colored background. As a result of consistent usage computer users are now familiar with this representation of a simple stream of pages. In the same way the use of scroll bars and “page up” and “page down” keys has become a part of the baseline knowledge that new staff may be expected to already understand. These commonly understood representations and methods of interaction do not, however, extend to a more complex collection of documents that is more than a simple, ordered, sequence of pages.

### BRIEF SUMMARY

One embodiment is a method of presenting documents that includes providing a single file comprising a plurality of documents, an identifier for each of the plurality of documents, and an indicator for each of the plurality of documents to indicate in which one of a plurality of predefined sections that document belongs and to indicate a position of that document in that section. Each document has been created individually and added to the single file. The method further includes displaying a graphical interface that appears as a notebook binder with a plurality of tabs, each tab corresponding to a one of the plurality of sections; and displaying a portion of at least one of the plurality of documents on a graphical page of the notebook binder of the graphical interface.

Another embodiment is a computer readable storage medium having processor-executable instructions, the processor-executable instructions when installed onto a system enable the system to perform actions. The actions include providing a single file comprising a plurality of documents, an identifier for each of the plurality of documents, and an indicator for each of the plurality of documents to indicate in which one of a plurality of predefined sections that document belongs and to indicate a position of that document in that section, wherein each document has been created individually and added to the single file. The actions further include displaying a graphical interface that appears as a notebook binder with a plurality of tabs, each tab corresponding to a one of the plurality of sections; and displaying a portion of at least one of the plurality of documents on a graphical page of the notebook binder of the graphical interface.

Yet another embodiment is a system for managing and presenting document. The system includes means for providing a single file comprising a plurality of documents, an identifier for each of the plurality of documents, and an indicator for each of the plurality of documents to indicate in which one of a plurality of predefined sections that document belongs and to indicate a position of that document in that section, wherein each document has been created individually and added to the single file. The system further includes means for displaying a graphical interface that appears as a notebook binder with a plurality of tabs, each tab corresponding to a one of the plurality of sections; and means for displaying a portion of at least one of the plurality of documents on a graphical page of the notebook binder of the graphical interface.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed;

FIG. 2 is a schematic conceptualization of one embodiment of a binder file, according to the invention;

FIG. 3 is a schematic representation of elements of one embodiment of a system for management and display of content of a binder file, according to the invention; and

FIG. 4 is schematic representation of one embodiment of an interface for displaying content of a binder file, according to the invention.

### DETAILED DESCRIPTION

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of computing device that includes a processor or any combination of computing devices where each device performs at least part of the process.

Suitable computing devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

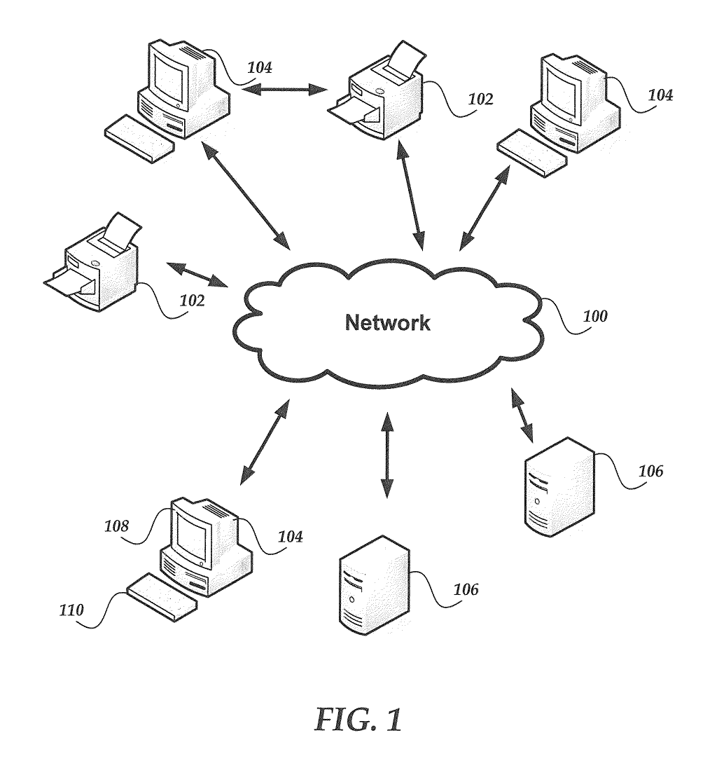

FIG. 1 illustrates one embodiment of an environment for the invention. In FIG. 1, a network environment is illustrated, but it will be understood that the invention is also applicable to unnetworked computing devices as well. It will be understood that the network environment can be a local area network, a wide area network, or any combination thereof. It will also be understood that the network can include devices, other than those illustrated, coupled to the network and that there may be multiple devices of each type illustrated connected to the network. The illustrated environment includes a network 100 to which is attached, either directly or through other devices, one or more computing devices 104 (e.g., computers, workstations, and the like), one or more printers 102, and one or more servers 106. Other devices can optionally be attached to the network such as personal data assistants (PDA's), cellular telephones, portable storage devices (e.g., compact discs, DVDs, memory sticks, flash drives, or other optical or magnetic storage media), and the like. Any of these devices can be connected directly to the network or via another device such as a computing device 104, printer 102, or server 106. A computing device 104 typically includes a display 108 and one or more input devices 110, such a keyboard, mouse, trackball, and the like. The computing device will also typically include internal components, such as a processor, a mass memory, and one or more components for reading portable computer-readable media, as described above.

Storage and presentation of related documents together is one method of increasing efficiency. In the office and other environments, physical documents are often collected into physical binders (using, for example, a ring-binder, lever-arch binder, comb- or ring-binding) for storage and reference. Often the documents within the binder are divided into sections, where each section contains different classes (e.g., different subject matter or different type) of document. As an example a home user may file utility bills into a binder with electricity in one section, telephone bills into another section, and so on. Similarly, an accounts clerk may file invoices relating to different suppliers or different date ranges into separate sections. To provide a clear demarcation between the sections, and to allow for easy navigation when searching for a document within the binder, dividers may be used between the sections. Such dividers may be made from a heavier or stiffer medium than that on which the regular pages are printed, may be colored and may include a tab that extends beyond the edges of the pages of the documents within the binder. Each of these characteristics enables the division between sections to be found more easily and quickly.

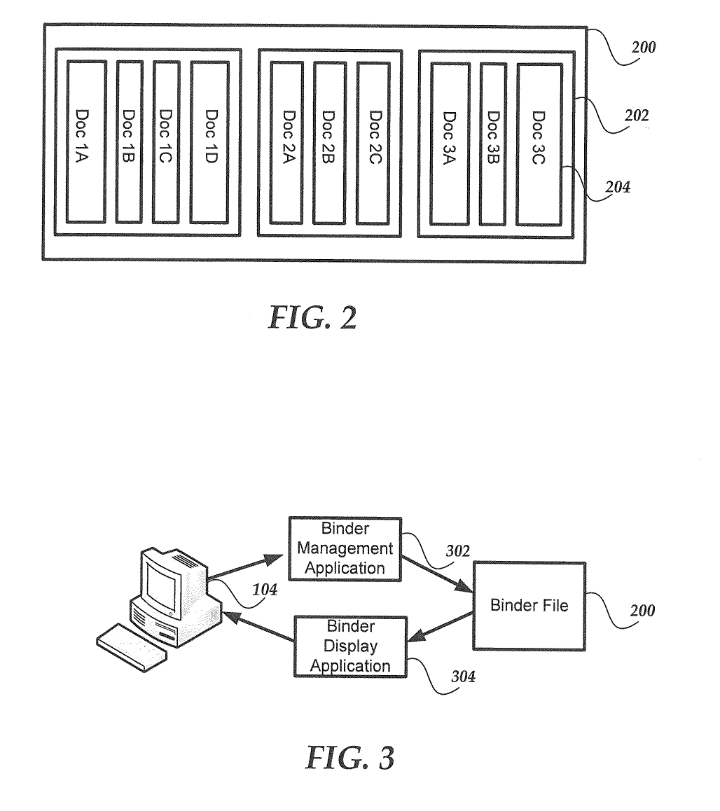

The present invention is directed, at least in part, to storing documents in a file (preferably, a single file) using a format that is conceptually similar to a physical binder with separate sections. The present invention is also directed to a displayable interface that utilizes a file stored in this format and presents the documents within the file in a representation that is reminiscent of a binder. A file with a binder format can be used to store multiple ‘documents’ within ‘sections’ within a single ‘binder’ file. FIG. 2 conceptually illustrates this concept with a binder file 200 containing multiple sections 202 with documents 204 distributed within the sections.

The binder file can include metadata. For example, the metadata may include one more of the following: an identifier for each document (e.g., a number or a title for each document); an indicator in which section a document belongs; a locator for each document designating a defined position within a section; a label for each section (and possibly additional identification such as a color); or the order of sections within the binder. Other metadata may also be included for one or more (or even each) document, section, or binder such as creator or author name(s); creation date; identification of the source document from which this document within the binder was imported (as a directory/file path or as an identifier within a content management system or other infrastructure repository); the time/date at which the document or section was last modified; the time/date at which the document or section was created or added to the binder; a time/date in the future by which some activity must be performed; a table of contents for the binder; binder name; the storage location of one or more copies of the binder file (e.g., to allow for automatic updating of the copies when the binder file is altered); alternate document or section titles; recipient name(s) or title(s); keyword(s); and other items such as those described by the Dublin Core Metadata Initiative or that may be desirable for a specific use case.

As illustrated in FIG. 3, the binder file 200 can be created and modified using a binder management application 302. The binder file 200 can be displayed on a computing device 104 using a binder display application 304. It will be understood that the binder management application 302 and binder display application 304 can be components of a single software application or can be separate applications or even divided among any number of different application. Moreover, the binder management application 302 and binder display application 304 may reside on the same computing device or may reside on different devices. For example, a binder file 200 may be generated using the binder management application 302 on one computing device or using an external server and then imported to another computing device or server for display using the binder display application 304. In some instances, components of either or both of the binder management application and binder display application may reside on different computing devices or servers.

The documents within the binder file, or to be added to the binder file, do not need to be originally in the same file format or from the same application. For example, the documents within the binder file can be created as separate files by the user (e.g. in a word processor, spreadsheet, or presentation application), received as email or as attachments to email, or extracted from a content management system or other organizational infrastructure. In at least some embodiments, the binder management application converts the document into a uniform format and adds the document to the binder file with the associated metadata. The metadata may be provided with the document or may be submitted by a user or any combination thereof.

In at least some embodiments, the separate documents can be added to the binder file using the binder management application which provides a user interface enabling selection of the document and placement into a binder. Alternatively or additionally, the addition of a document to the binder file may be performed automatically or semi-automatically according to pre-defined rules, e.g. by an application running on a server, client, or other computer.

The binder display application can open and display a binder file and enable the user to read and interact with the binder file and the documents and metadata within the binder file. Optionally, the binder display application may include some or all of the functionality of the native application in which the original document was generated. In some embodiments, the functionality may be limited and may not allow modification of the document or limited modification of the document. In some embodiments, the binder display application may include additional functionality such as highlighting, annotating, bookmarking, and redaction functions.

The binder display application may also include controls for deleting a document, adding a document, or rearranging documents within a section or within the binder file.

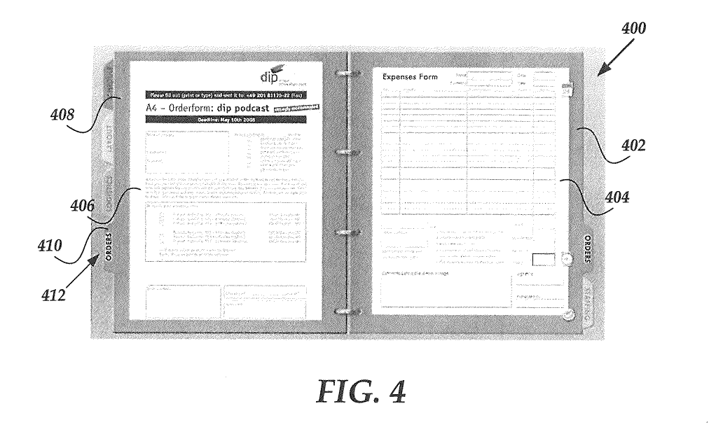

In at least some embodiments, the binder display application displays the binder on the computer screen in a manner reminiscent of an opened physical binder. One example of such a display 400 is provided as FIG. 4. The binder interface 402 may be depicted as any type of binder, for example, a ring binder, lever arch binder, spiral binder, comb binder or any other suitable representation. At least one page 404 (or other portion) of a document 406 can be shown on the binder 402. One or two or more pages may be displayed in the interface. FIG. 4 illustrates the display of two pages in the interface. The number of pages that is displayed may be a user-definable feature.

In at least some embodiments, the sections are represented as if dividers 408 were present between them. Each of the dividers may be uniquely colored to further distinguish the sections. Also, each divider 408 may include a tab 410 on the outside edge of the divider. Optionally, the tab may have a label 412 associated with that section.

In at least some embodiments, this interface and file format leverages the representation of a binder containing multiple sections on a computer display in a software application in such a way that the methods of navigating around the collection is relatively intuitive. This can lead to significantly reduced training and support requirements for computer users.

The binder display application may include a variety of different functional features to facilitate display of the documents of the binder file. For example, for at least some embodiments, clicking on a tab (or possibly the divider) that relates to the currently displayed section at the left side of the binder representation will show the first document within the section; clicking on the tab (or possibly the divider) that relates to the currently displayed section at the right side of the binder representation will show the last document within the section. This is equivalent to a user physically holding down that tab while turning all the pages within the section to one side or the other.

In at least some embodiments, clicking on a colored tab related to a section other than the one currently displayed will move to the first document within the section selected. This is equivalent to a user physically holding the tab and turning pages within a binder.

In at least some embodiments, one or more other paging controls may be provided. For example, pressing a “page up” and “page down” key on a keyboard (or activating soft-keys on a display) can move through the binder in a linear fashion, both within a section, and from the last page of one section to the first of the next (or vice versa). In some embodiments, a key or command may also allow for moving from one section to the next. In some embodiments, a control can be provided for moving to the beginning or send of the binder or a section of the binder. In some embodiments, a control can be provided for moving to the next, or previous, document or the next, or previous, section.

In at least some embodiments, the size of each tab displayed on the edge of the section dividers is fixed. In other embodiments, the size of each tab may change automatically depending on the number of sections within the binder so as to allow the user to see all tabs at once.

In at least some embodiments, the binder display application allows pages or documents to be copied or moved between binders in order to create or amend a binder.

This model of opening and displaying a hierarchical document structure as a ring binder may be applied in cases where the documents are not provided in a single binder file format. Thus, separate files within a directory or folder structure on a computer storage medium, for instance, may also be displayed using the binder representation described herein.

It will be understood the three level hierarchy of document/section/binder is not exclusive and that the binder display metaphor may be extended to other depths, for example, by the depiction of several sizes of dividers. Thus the tabs for the dividers between sub-sections may extend no further than the edge of the dividers between sections, enabling all tabs for sections and sub-sections to be seen simultaneously.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of presenting documents, the method comprising:
providing a single file comprising a plurality of documents, an identifier for each of the plurality of documents, and an indicator for each of the plurality of documents to indicate in which one of a plurality of predefined sections that document belongs and to indicate a position of that document in that section, wherein each document has been created individually and added to the single file;
displaying a graphical interface that appears as a notebook binder with a plurality of tabs, each tab corresponding to a one of the plurality of sections; and
displaying a portion of at least one of the plurality of documents on a graphical page of the notebook binder of the graphical interface.

2. The method of claim 1, wherein displaying the graphical interface comprises displaying each of the plurality of tabs using a different color.

3. The method of claim 1, further comprising actuating a one of the tabs and displaying on the graphical page a portion of a one of the plurality of documents, wherein the one of the plurality of documents belongs to the section corresponding to the actuated tab.

4. The method of claim 3, wherein actuating a one of the tabs comprises displaying on the graphical page a portion of a one of the plurality of documents, wherein the one of the plurality of documents belongs to the section corresponding to the actuated tab and is indicated as in a first position for that section.

5. The method of claim 3, further comprising paging through at least one of the documents of the section corresponding to the actuated tab by actuating a one of at least one paging control.

6. The method of claim 5, further comprising switching to another section using a paging control.

7. The method of claim 1, wherein displaying a portion of at least one of the plurality of documents comprises displaying two portions of at least one of the plurality of documents in two graphical pages of the notebook binder of the graphical interface.

8. The method of claim 1, wherein providing a single file comprises
receiving a document for inclusion in the single file;
converting the document to a file format of the single file;
identifying a one of the plurality of sections to which the document belongs and generating an indicator for the document;
generating an identifier for the document; and
adding the document, the indicator for the document, and the identifier for the document to the single file.

9. The method of claim 1, wherein providing a single file comprises providing a unique title for each of the plurality of sections.

10. The method of claim 1, wherein providing a single file comprises providing a title for each of the plurality of documents.

11. The method of claim 1, wherein providing a single file comprises providing a date for each of the plurality of documents corresponding to a date on which the document was created, added to the single file, or updated within the single file.

12. A computer readable storage medium having processor-executable instructions, the processor-executable instructions when installed onto a system enable the system to perform actions, comprising:
providing a single file comprising a plurality of documents, an identifier for each of the plurality of documents, and an indicator for each of the plurality of documents to indicate in which one of a plurality of predefined sections that document belongs and to indicate a position of that document in that section, wherein each document has been created individually and added to the single file;
displaying a graphical interface that appears as a notebook binder with a plurality of tabs, each tab corresponding to a one of the plurality of sections; and
displaying a portion of at least one of the plurality of documents on a graphical page of the notebook binder of the graphical interface.

13. The computer-readable storage medium of claim 12, wherein the processor-executable instructions further enable the system to perform actions comprising:
receiving a document for inclusion in the single file;
converting the document to a file format of the single file;
identifying a one of the plurality of sections to which the document belongs and generating an indicator for the document;
generating an identifier for the document; and
adding the document, the indicator for the document, and the identifier for the document to the single file.

14. The computer-readable storage medium of claim 12, wherein the processor-executable instructions further enable the system to perform actions comprising paging through at least one of the documents of the section corresponding to the actuated tab by actuating a one of at least one paging controls.

15. The computer-readable storage medium of claim 12, wherein displaying the graphical interface comprises displaying each of the plurality of tabs using a different color.

16. The computer-readable storage medium of claim 12, wherein actuating a one of the tabs comprises displaying on the graphical page a portion of a one of the plurality of documents, wherein the one of the plurality of documents belongs to the section corresponding to the actuated tab and is indicated as in a first position for that section.

17. A system for managing and presenting documents, comprising:
means for providing a single file comprising a plurality of documents, an identifier for each of the plurality of documents, and an indicator for each of the plurality of documents to indicate in which one of a plurality of predefined sections that document belongs and to indicate a position of that document in that section, wherein each document has been created individually and added to the single file;
means for displaying a graphical interface that appears as a notebook binder with a plurality of tabs, each tab corresponding to a one of the plurality of sections; and
means for displaying a portion of at least one of the plurality of documents on a graphical page of the notebook binder of the graphical interface.

18. The system of claim 17, further comprising:
means for receiving a document for inclusion in the single file;
means for converting the document to a file format of the single file;
means for identifying a one of the plurality of sections to which the document belongs and generating an indicator for the document;
means for generating an identifier for the document; and
means for adding the document, the indicator for the document, and the identifier for the document to the single file.
